(19) United States
(12) Patent Application Publication
(10) Pub. No.: US 2004/0051337 A1
(43) Pub. Date: Mar. 18, 2004

(54) Visor assembly having electronics package

(75) Inventor: Rodger W. Eich, Holland, MI (US)

Correspondence Address: Steven C. Becker, Foley & Lardner, 777 East Wisconsin Avenue, Milwaukee, WI, 53202-5367, US

(73) Assignee: Johnson Controls Technology Company

(21) Appl. No.: 10/246,332

(22) Filed: Sep. 18, 2002

(51) Int. Cl. B60J 3/04

(52) U.S. Cl. 296/97.5

(57) ABSTRACT

A visor assembly for use in a vehicle comprises a visor having first and second surfaces, a package coupled to the visor, and a mirror coupled to the package and viewable along with the first surface of the visor. The visor assembly further comprises an electronic device coupled to the package and a user interface coupled to the electronic device and viewable along with the second surface of the visor.

### BACKGROUND OF THE DISCLOSURE

Most automotive vehicles include sun visors coupled on or near the interior roof of the vehicle. A typical sun visor includes two substantially flat surfaces and a hinged connection to the roof of the vehicle, such that the sun visor can be moved to a deployed position to shade light exterior to the vehicle from a front seat occupant's view and to a stowed-away position wherein the occupant's view is not shielded.

The trend in the automotive industry has been to incorporate more and more electronic devices within the vehicle interior to provide further comfort and convenience features to occupants of the vehicle. One convenient place for locating such electronic features is the visor. In one system, a visor includes a radio frequency garage door opening transmitter and a thin foil strip extending along the longitudinal length of the visor to act as an antenna.

However, packaging electronics components in a visor reduces the amount of space available for a mirror. Furthermore, locating electronics components at different places on the visor can increase clutter and can require multiple wiring harnesses, which results in a more costly and labor-intensive assembly process.

Accordingly, there is a need for an improved visor assembly for use in a vehicle which optimizes the packaging space for electronic content and a mirror. Further, there is a need for a visor assembly having electronics and a mirror which allows for quick port installs of different product versions. Further still, there is a need for additional package space in a visor assembly to accommodate radio frequency-based electrical components. Further still, there is a need for a visor assembly having reduced clutter and a more cost-effective assembly process. The teachings hereinbelow extend to those embodiments which fall within the scope of the appended claims, regardless of whether they accomplish one or more of the above-mentioned needs.

### SUMMARY OF EXEMPLARY EMBODIMENTS

According to one exemplary embodiment, a visor assembly for use in a vehicle comprises a visor having first and second surfaces, a package coupled to the visor, and a mirror coupled to the package and viewable along with the first surface of the visor. The visor assembly further comprises an electronic device coupled to the package and a user interface coupled to the electronic device and viewable along with the second surface of the visor.

According to another exemplary embodiment, a vanity pack comprises a package having first and second surfaces opposite one another and an enclosure disposed between the first and second surfaces configured to house an electronic circuit board. The vanity pack further comprises a mirror coupled to the first surface, and at least one user input surface disposed on the second surface configured for user interface.

According to another exemplary embodiment, a visor assembly for a vehicle comprises a substantially flat visor element having first and second opposite surfaces and a means for enclosing an electronic device and for providing a mirror at the first surface and an operator input device at the second surface.

According to yet another exemplary embodiment, a visor assembly comprises an elongated shield having first and second sides and a package integral with the elongated shield comprising a means for mirroring an image on the first side of the shield and a means for housing a user interface accessible via the second side of the shield.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1. is a diagram of a first surface of a visor assembly, according to an exemplary embodiment;

FIG. 2 is a diagram of a second surface of a visor assembly, according to an exemplary embodiment;

FIG. 3 is a diagram of a visor assembly having a vanity mirror, according to an exemplary embodiment;

FIG. 4 is a perspective view of a method of making a visor assembly, according to an exemplary embodiment;

FIG. 5 is an exploded view of the visor assembly of FIG. 4, according to an exemplary embodiment; and

FIG. 6 is a cross-sectional view of the visor assembly of FIG. 4, according to an exemplary embodiment.

### DETAILED DESCRIPTION OF EXEMPLARY EMBODIMENTS

Referring first to FIG. 1, a visor assembly 10 is illustrated. Visor assembly 10 is configured to be coupled to a vehicle interior, which can be the interior of an automobile, truck, minivan, work vehicle, or other vehicle. Visor assembly 10 comprises a visor body 12 which can be of a molded polymeric material such as polypropylene or other materials such as fiberboard which can be preformed in a butterfly shape and folded over in a clam-shell design to complete the visor body construction. Visor body 12 can be covered with a fabric, leather, or other aesthetic and tactile material. Visor body 12 is coupled to the roof of a vehicle or other vehicle interior element (e.g., pillar, door, etc.) by a coupling assembly (not shown) which can be of conventional construction. The coupling assembly can be an elbow bracket assembly and can include a pivot rod extending into visor body 12. A torque fitting coupled to visor body 12 engages the pivot rod for allowing the visor to be held in a raised, stored position or a plurality of lowered, deployed positions, and also to allow the visor to be moved from the front windshield position to the side window position in a conventional manner. A support rod 14 is coupled to visor body 12 and is configured for a removable coupling to a support receptacle (not shown) mounted to a vehicle roof.

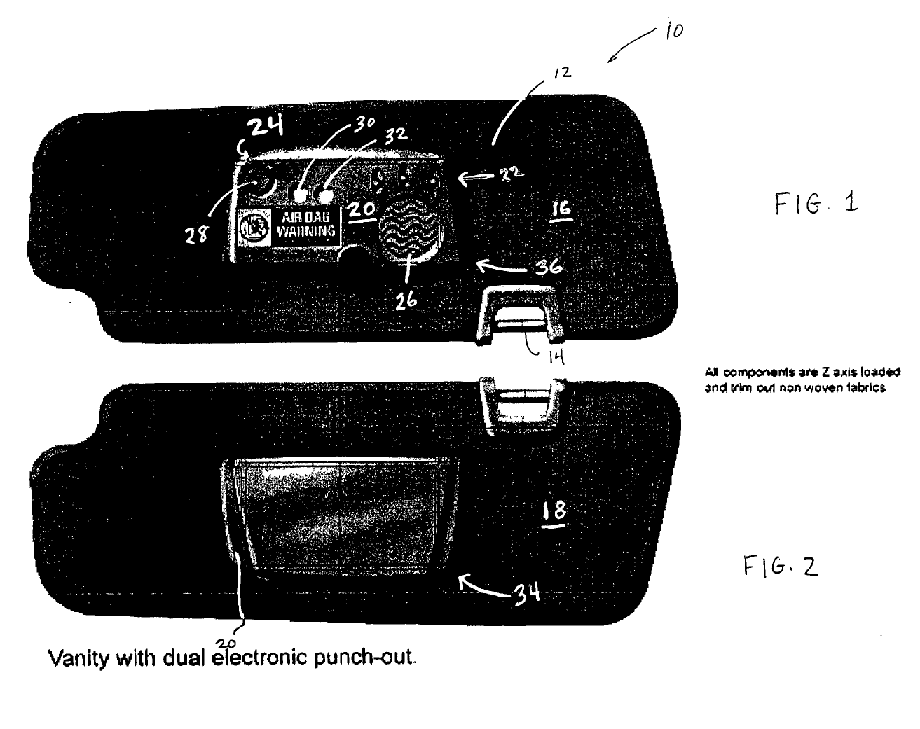

Visor body 12 includes a surface 16 which is substantially flat and opposite a surface 18 (FIG. 2). In this exemplary embodiment, surface 16 is viewable by or visible to a vehicle occupant in a first, stowed position and is concealed from a vehicle occupant in an open or deployed position. Surface 18 is viewable by or visible to a vehicle occupant in the open or deployed position and is concealed from a vehicle occupant in the first, stowed position. Such movement is provided by the above-described coupling arrangement between visor body 12 and the roof of the vehicle interior, which may include a hinge, or other coupling device.

Visor body 12 includes a package 20 coupled to visor body 12. Package 20 comprises a plastic or other polymeric material in this embodiment, but may alternatively comprise other materials. Package 20 defines an enclosure therein of sufficient size and shape to house an electronic device. The electronic device may be housed or disposed at least partially, substantially (i.e., more than 50% of the electronic device) or completely within package 20. Package 20 can comprise one molded part or a plurality of parts coupled together using a fastener, such as, glue, screws, an interference fit, etc.

In this exemplary embodiment, package 20 houses two electronic devices: a trainable transceiver and a memo recorder. The trainable transmitter includes a radio frequency transmitter and a radio frequency receiver coupled to a control circuit on a circuit board disposed in the enclosure defined by package 20. The trainable transmitter is concealed by package 20 from the occupant's view. The trainable transmitter can be trained to one or more original transmitters employed for remotely controlling home, office, or vehicle accessories, such as a garage door opening mechanism, home lighting, home security, etc. In a training mode, an existing original transmitter transmits a radio frequency or other wireless signal on a carrier frequency. The trainable transmitter is configured to learn the frequency and data code from the signal and to store data representing the frequency and data code. In an operation mode, the trainable transmitter transmits the frequency and data code to the accessory to be controlled. The data code can be modulated according to a modulation scheme and can be encrypted using a rolling code algorithm or can be a fixed code.

The memo recorder comprises a speaker or microphone and a control circuit configured to receive audible signals at the microphone, to store the audio signals, and to replay the audio signals at the speaker.

Both of the electronic devices housed within package 20 include user interfaces in this exemplary embodiment. A trainable transmitter interface 22 includes three operator-actuated switches which control the operation of the trainable transceiver during learning and operating modes. For example, each of the switches can be programmed to control a different appliance. Trainable transmitter interface 22 is coupled to the trainable transmitter circuit and is also viewable or accessible by a vehicle occupant along with surface 16.

A memo recorder user interface 24 includes a speaker/microphone 26, a record button 28, a next message button 30, and a play button 32. In operation, the user presses record button 28 and speaks near speaker/microphone 26. In response, the control circuit associated with the memo recorder records the message and stores it in a memory, such as a digital memory. Multiple messages can be recorded. Play button 32 can be actuated to begin play back of a message. Next message button 30 can be used to cycle through a plurality of messages.

According to one advantageous feature, memo recorder user interface 24 can include a microphone, which can be coupled to an elbow bracket which acts as a movable coupling between visor body 12 and the roof of the vehicle.

The trainable transmitter and memo disclosed herein are exemplary electronic devices which may be housed within package 20. Other electronic devices can be housed in package 20 individually or in combination with other electronic devices. Accordingly to one exemplary embodiment, the electronic devices housed in package 20 are configured to perform occupant convenience functions, such as, wirelessly controlling accessories remote to the vehicle, wirelessly or controlling via wire accessories coupled to the vehicle, controlling a vehicle anti-theft device, generating and displaying compass heading or temperature information to an occupant, providing a memo recorder for a vehicle occupant, providing access to a nearby wireless phone via a Bluetooth communications protocol or other wireless communications protocol, etc. Further, the electronic device or devices disposed within package 20 can be a portion or component of an electronic system configured to provide an occupant convenience function or to provide some other vehicle-related function. The electronic device or devices disposed within package 20 can include one or more control circuits (e.g., analog and/or digital circuit components, a microprocessor, a microcontroller, etc.), frequency or infrared communication devices, user interface components (e.g., buttons, switches, a display, which can include an icon, a light-emitting diode, a reconfigurable display, such as, a vacuum fluorescent display, liquid crystal display, etc.).

Referring now to FIG. 2, one advantageous aspect of this exemplary embodiment is disclosed. Package 20 includes a vanity mirror portion 34 extending from surface 18 of visor body 12. As shown in FIG. 1, package 20 includes a user interface portion 36 extending from surface 16 of visor assembly 10. Vanity mirror portion 34 and user interface portion 36 of package 20 define an outer surface of package 20, a first portion of which extends from and is viewable with surface 16 of visor body 12 and a second portion of which extends from and is viewable with surface 18 of visor body 12. The two portions are spatially aligned on visor body 12 such that at least a portion of each of the two portions overlaps spatially.

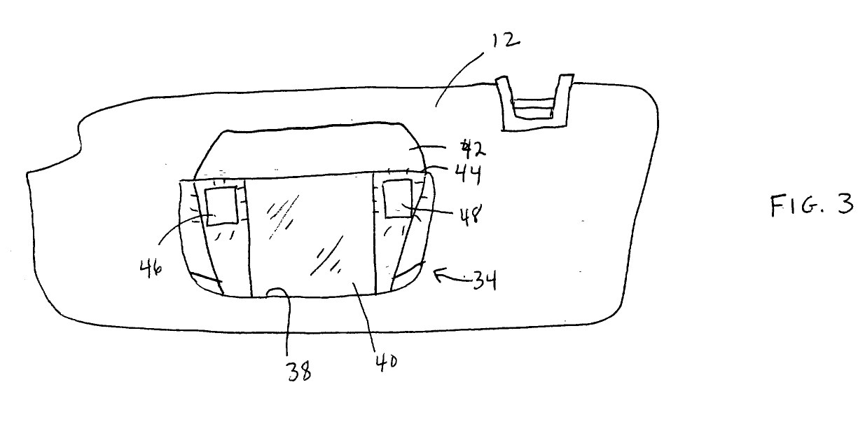

Referring to FIG. 3, vanity mirror portion 34 of package 20 defines a recess 38 in which a mirror 40 is disposed. Mirror 40 can be coupled to package 20 and/or visor body 12 using any of a plurality of fasteners, such as, glue, screws, an interference or friction fit, etc. In this embodiment, mirror 40 is coupled to vanity mirror portion 34. Cover 42 is coupled via a hinge 44 or other movable coupling to vanity mirror portion 34 of package 20. Cover 42 is movable between a closed position (FIG. 2) in which cover 42 conceals at least a portion of mirror 40, and preferably all of mirror 40, and an open position (FIG. 3) in which the portion or entire mirror 40 is not concealed, from the point of view of a vehicle occupant seated in the vehicle. In this embodiment, light sources 46 and 48 are coupled to electronic circuitry disposed within package 20, which circuitry is configured to detect the position of cover 42 and to illuminate light sources 46 and 48 (e.g., incandescent light bulbs, fluorescent light bulbs, light-emitting diodes, etc.) when cover 42 is open and to turn light sources 46 and 48 off when cover 42 is closed.

According to one advantageous aspect, package 20 is configured to house an electronic device which includes a circuit board, which device is disposed between mirror 40 and at least one of user interfaces 22 and 24 (FIG. 1). According to a further feature, the circuit board is sandwiched, or inserted or enclosed between mirror 40 and user interfaces 22, 24. In alternative embodiments, one or more portions of the circuit board may be disposed outside of the area between mirror 40 and at least one of user interfaces 22, 24.

According to another exemplary embodiment, a vanity pack comprises package 20 having a surface associated with user interface portion 36 and a surface associated with vanity mirror portion 34, which surfaces are disposed opposite one another. Package 20 defines an enclosure disposed between the first and second surfaces of package 20, the enclosure configured of suitable size and shape to house an electronic circuit board. The vanity pack further includes mirror 40 coupled to the first surface and at least one user input surface configured to receive user input devices disposed on the second surface. The user input surface can be an aperture configured to receive a button or switch. In this manner, the second surface is configured for receiving user input devices to act as a user interface to the electronic circuit board. The vanity pack can further include the electronic device disposed in the enclosure and a user interface coupled to the second surface and configured to provide operator inputs to the electronic device. The vanity pack can further include one or more of the features described hereinabove with reference to FIGS. 1-3.

Referring now to FIGS. 4-6, a method of making a visor assembly will be described, according to an exemplary embodiment. Referring first to FIG. 4, visor body 12 comprises a first visor body portion 50 coupled to a second visor body portion 52 via a hinge or other fastener 54. Portions 50 and 52 are fabricated from a single plastic substrate in this embodiment via a stamping, cutting, or other process. The fabrication process comprises providing an aperture 56, 58 in each of portions 50 and 52, wherein the aperture is adapted to or configured to receive package 20 therein. Accordingly, body 12 is a plastic “clam shell” substrate. A fabric or other material is provided in one or more pieces to cover first surface 16 and second surface 18 (not shown), wherein a small portion of the fabric extends around an outer edge 60 of body 12 and onto surfaces 62, 64. The small portion can be approximately between one quarter and one inch, and preferably is a sufficient quantity such that, upon closure of halves 50 and 52, the portion of fabric is captured, fixed, or fastened between surfaces 62 and 64 of portions 50 and 52. An additional fastener, such as glue, etc. may be applied during the fabrication process.

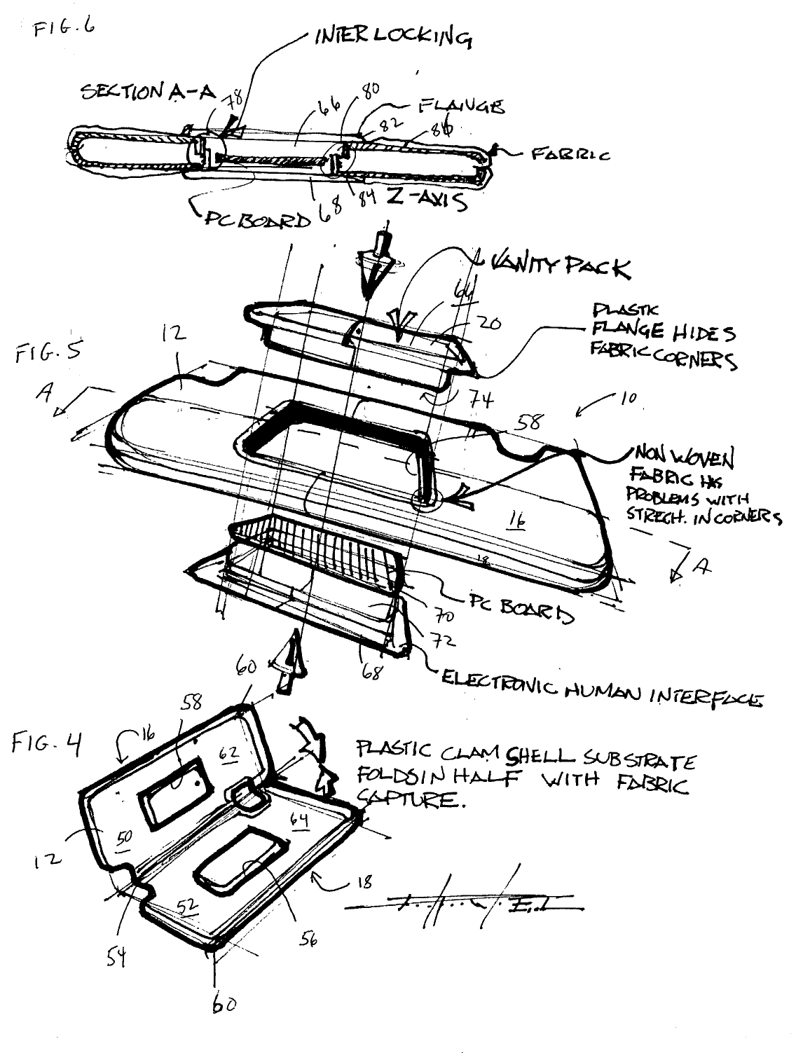

Referring to FIG. 5, body 12 is shown in a closed configuration, which may be after the clam shell substrate is folded in half Thus, fabric is shown on surface 16 and surface 18. In this embodiment, package 20 comprises a first portion 66 and a second portion 68. In this embodiment, second portion 68 provides a user interface or electronic human interface, such as buttons, switches, displays, etc. Portion 66 is coupled to a mirror and viewable along with first surface 26. An electronic device 70 comprising a circuit board, such as a printed circuit board, is configured to be disposed between portion 66 and 68, and more specifically, between a recess 72 and a recess 74 defined by portions 66 and 68. Portion 66 is provided into aperture 58 from a first direction relative to aperture 58 and portion 68 is provided into aperture 58 from a second direction relative to aperture 58, with electronic device 70 disposed between first and second portions 66 and 68. Portions 66 and 68 meet and are fastened together to form the visor assembly of this exemplary embodiment.

Referring to FIG. 6, a cross-sectional view of visor assembly 10 is shown, illustrating an exemplary fastening method and further advantages of this embodiment. First portion 66 meets second portion 68 at first and second interlocking structures 78, 80. The interlocking structures can couple portions 66 and 68 by an interference fit, by ridges, by threads, by glue, screws, or any other fasteners. Portions 66 and 68 each include a flange 82, 84, which may be a bezel, which covers a portion of fabric 86. Flanges 82 and 84 are particularly advantageous when fabric 86 is a non-woven fabric, since non-woven fabric experiences problematic stretching in corners of an aperture, as shown in FIG. 5. Flanges 80 and 84 hide any problems or inconsistencies with stretching of the non-woven fabric from the viewer's perspective.

According to a further advantage, portions 66 and 68 and electronic device 70 are z-axis loaded. The z-axis load and flanges 82 and 84 advantageously reduce stretch problems with non-woven fabric, such as trim out (i.e., portions of fabric 86 which are removed near aperture 58).

In the plurality of embodiments disclosed with reference to FIGS. 1-6, visor body 12 is substantially flat and has opposite surfaces 16 and 18. In alternative embodiments, visors may take other shapes and may have other cross-sectional shapes, such as, a triangle, and may further have curved surfaces. As a further alternative, the visor assembly may include any elongated shield having first and second sides. The shield may be a visor or may alternatively be another component of a vehicle interior, or may further alternatively be any elongated surface configured to shield light. In this embodiment, the elongated shield can be integral with a package by coupling thereto, by being molded therewith, or otherwise, and the package includes a mirror or other reflective device on a first side of the shield and a housing configured to provide a user interface accessible to a vehicle occupant on the second side of the shield.

One or more embodiments described herein can provide the benefits of an ideal location for radio frequency-based electronics, a self-contained visor having electronics which allow for quick port installs of different levels of products, and/or a self-contained feature for adding electronics to a visor.

While the exemplary embodiments illustrated in the FIGS. and described above are presently preferred, it should be understood that these embodiments are offered by way of example only. For example, the mirror can include one or more smaller mirrors, and can include various configurations and compositions. Accordingly, the present invention is not limited to a particular embodiment, but extends to various modifications that nevertheless fall within the scope of the appended claims.

What is claimed is:

1. A visor assembly for use in a vehicle, comprising:
a visor having first and second surfaces;
a package coupled to the visor;
a mirror coupled to the package and viewable along with the first surface of the visor;
an electronic device disposed at least partially within the package; and
a user interface coupled to the electronic device and viewable along with the second surface of the visor.

2. The visor assembly of claim 1, wherein the visor is substantially flat and the first and second surfaces are opposite one another.

3. The visor assembly of claim 1, wherein the electronic device includes a circuit board disposed in the package between the mirror and the user interface.

4. The visor assembly of claim 3, wherein the circuit board is sandwiched between the mirror and the user interface.

5. The visor assembly of claim 1, further comprising a hinge configured to be coupled to a vehicle interior and configured to provide movement of the visor from a first, stowed position in which the user interface is viewable by a vehicle occupant and a second, open position in which the mirror is viewable by a vehicle occupant.

6. The visor assembly of claim 1, wherein the electronic device includes at least one of a radio frequency transmitter and a radio frequency receiver.

7. The visor assembly of claim 1, wherein the package defines an enclosure and the electronic device comprises a circuit board disposed in the enclosure is concealed from an occupant's view.

8. The visor assembly of claim 7, further comprising a second electronic device configured to perform an occupant convenience function different from an occupant convenience function performed by the electronic device.

9. The visor assembly of claim 8, wherein the second electronic device includes a second circuit board disposed in the enclosure and concealed from an occupant's view.

10. The visor assembly of claim 1, wherein the package includes an outer surface having a first portion extending from the first surface of the visor and a second portion extending from the second surface of the visor, wherein the mirror is coupled to the first portion and the user interface is coupled to the second portion.

11. A vanity pack, comprising:
a package having first and second surfaces opposite one another and an enclosure disposed between the first and second surfaces configured to house an electronic circuit board; and
a mirror coupled to the first surface, and at least one user input surface disposed on the second surface configured for a user interface to the electronic circuit board.

12. The vanity pack of claim 11, further comprising:
an electronic device disposed in the enclosure; and
a user interface coupled to the second surface configured to provide operator inputs to the electronic device.

13. The vanity pack of claim 12, wherein the mirror and user interface sandwich the electronic device.

14. The vanity pack of claim 12, wherein the electronic device comprises a trainable radio frequency transmitter.

15. The vanity pack of claim 12, wherein the electronic device comprises a circuit configured to record and play back an audible message, wherein the user interface comprises a microphone.

16. The vanity pack of claim 12, further comprising a second electronic device configured to perform an occupant convenience function different than an operator convenience function performed by the electronic device.

17. The vanity pack of claim 11, further comprising a moveable cover coupled to the package configured to move between a first position in which the cover conceals at least a portion of the mirror and a second position in which the portion is not concealed.

18. A visor assembly for a vehicle, comprising:
a substantially flat visor element having first and second opposite surfaces; and
means for enclosing an electronic device and for providing a mirror at the first surface and an operator input device at the second surface.

19. The visor assembly of claim 18, further comprising hinge means for moving the substantially flat visor between a first position revealing the mirror and a second position revealing the operator input device.

20. A visor assembly, comprising:
an elongated shield having first and second sides;
a package integral with the elongated shield comprising means for mirroring an image on the first side of the shield and means for housing a user interface accessible via the second side of the shield.

21. The visor assembly of claim 20, wherein the means for displaying includes a mirror.
